(19) United States
(12) Patent Application Publication
(10) Pub. No.: US 2026/0171655 A1
(43) Pub. Date: Jun. 18, 2026

(54) ANTENNA DEVICE

(71) Applicant: KMW INC., Hwaseong-si (KR)

(72) Inventor: In Hwa CHOI, Yongin-si (KR)

(73) Assignee: KMW INC., Hwaseong-si (KR)

(21) Appl. No.: 19/533,160

(22) Filed: Feb. 7, 2026

Related U.S. Application Data
(63) Continuation of application No. PCT/KR2024/009668, filed on Jul. 8, 2024.

(30) Foreign Application Priority Data
Aug. 8, 2023 (KR) 10-2023-0103683
Sep. 1, 2023 (KR) 10-2023-0116138

(51) Int. Cl. H01Q 1/24; H01Q 1/38; H01Q 1/48; H01Q 9/42; H01Q 21/28; H01Q 21/30

(52) U.S. Cl. CPC H01Q 1/243; H01Q 1/38; H01Q 1/48; H01Q 9/42; H01Q 21/28; H01Q 21/30

(57) ABSTRACT

An antenna device is disclosed. According to one embodiment of the present disclosure, the provided antenna device comprises: one or more antenna boards which extend in the longitudinal direction, and which are formed such that each thereof has one or more circuit patterns; a dielectric formed such that a contact position for the one or more circuit patterns may be changed at the upper side of each of the one or more antenna boards; a connector protruding at the lower side of each of the one or more antenna boards from one surface thereof; and an antenna filter detachably coupled to the connector.

### CROSS-REFERENCE TO RELATED APPLICATION

This application is a continuation application of International Application No. PCT/KR2024/009668, filed Jul. 8, 2024, which claims the benefit of Korean Patent Application Nos. 10-2023-0103683, filed Aug. 8, 2023, and 10-2023-0116138, filed Sep. 1, 2023 in the Korean Intellectual Property Office, the disclosures of which are incorporated herein in their entirety by reference.

### TECHNICAL FIELD

The present disclosure relates to an antenna apparatus. More particularly, the present disclosure relates to an antenna apparatus including a phase conversion apparatus.

### BACKGROUND ART

The content described in this section merely provides background information for the present disclosure and does not constitute prior art.

An antenna device is most efficient in terms of coverage when a beam is formed in a horizontal direction; however, in some cases, a beam angle needs to be adjusted in a vertical direction due to interference, loss, or the like. In such a case, the beam angle of the antenna device in the vertical direction is adjusted through a mechanical beam tilt method or an electrical beam tilt method.

The mechanical beam tilt method is a method of adjusting a beam angle by installing the antenna device in a downwardly inclined manner. Although the method is simple, the method has drawbacks in that it is somewhat cumbersome due to various reasons such as a site visit by an operator and power interruption during operation.

The electrical beam tilt method is a method based on a Multi Line Phase Shifter (MLPS). Specifically, the electrical beam tilt method adjusts the beam angle by feeding signals having different phases to a plurality of radiating elements arranged in a vertical direction.

In order to implement an electrical beam tilting method, an antenna device may be provided with a phase conversion device. The phase conversion device delays an input signal in a controlled manner so as to generate a phase difference between the input signal and an output signal. In this case, the delay of the input signal may be implemented by changing a length of a transmission line or by changing a signal propagation speed within the transmission line.

In addition, in a massive MIMO system, a filter and an antenna subarray corresponding to each RF chain are provided, and the phase conversion device is disposed between the filter and the antenna subarray along an RF signal path. In the related art, the phase conversion device is disposed at a rear side of the antenna and is implemented using a separate transmission line medium, for example, a printed circuit board (PCB).

However, as the phase conversion device is additionally provided, not only does a volume of a product increase, but additional transmission loss also occurs. Accordingly, in order to transmit the same output, an output of a power amplifier must be increased by an amount corresponding to the increased loss. When the output of the power amplifier is increased, an amount of heat generation also increases, and thus a volume and a weight of a massive MIMO system housing further increase due to an increase in a size of a heat dissipation structure for heat dissipation.

### DETAILED DESCRIPTION OF THE INVENTION

### Technical Problem

Accordingly, the present disclosure has been made to solve the above-described problems, and a primary object thereof is to provide an antenna device capable of minimizing path loss caused by phase conversion, reducing an amount of heat generation, and decreasing an overall volume and weight of the device.

### Technical Solution

According to one embodiment of the present disclosure for achieving the above-described object, there is provided an antenna device comprising: one or more antenna boards which extend in a longitudinal direction and are formed such that each thereof has one or more circuit patterns; a dielectric formed such that a contact position for the one or more circuit patterns may be changed at an upper side of each of the one or more antenna boards; a connector protruding from one surface thereof at a lower side of each of the one or more antenna boards; and an antenna filter detachably coupled to the connector.

### Effects of the Invention

As described above, according to the present embodiment, even though a phase conversion function is provided, an increase in a volume of an antenna may be prevented. In addition, since phase conversion is implemented by applying a circuit pattern having a minimum path without generating a separate circuit pattern for phase conversion, path loss may be minimized. Accordingly, an increase in an amount of heat generation is suppressed, thereby achieving an effect of not increasing an overall volume and weight of the system. Further, by implementing a connector portion connected to an RF chain in an antenna module, a size of an antenna filter module may be minimized, and an internal space may be utilized more efficiently.

### BRIEF DESCRIPTION OF THE DRAWINGS

FIG. 1 is an exploded perspective view illustrating a part of an antenna device according to one embodiment of the present disclosure.

FIG. 2 is a combined perspective view as viewed from an upper side of the antenna device according to one embodiment of the present disclosure, and an enlarged view of some components thereof.

FIG. 3 is a combined perspective view as viewed from a lower side of the antenna device according to one embodiment of the present disclosure.

FIG. 4 is a cross-sectional view illustrating the antenna device of FIG. 2, taken along line A-A′ and shown with a cover removed.

FIG. 5 is a cross-sectional view illustrating an area in which an antenna filter is disposed, taken along line B-B′ of the antenna device of FIG. 2.

### DETAILED DESCRIPTION OF THE INVENTION

Hereinafter, some embodiments of the present disclosure will be described in detail using exemplary drawings. In adding reference numerals to components of each drawing, it should be noted that the same components are given the same reference numerals as much as possible even if they are shown in different drawings. Furthermore, in describing the present disclosure, when it is determined that a detailed description of related known configurations or functions may obscure the gist of the present disclosure, the detailed description thereof will be omitted.

In describing the components of an embodiment according to the present disclosure, symbols such as first, second, i), ii), a), b), etc. may be used. These symbols are only for distinguishing the component from other components, and the nature, sequence, or order of the component is not limited by such symbols. When a part of the specification is said to “include” or “comprise” a component, this means that other components may be further included rather than excluded, unless expressly stated to the contrary.

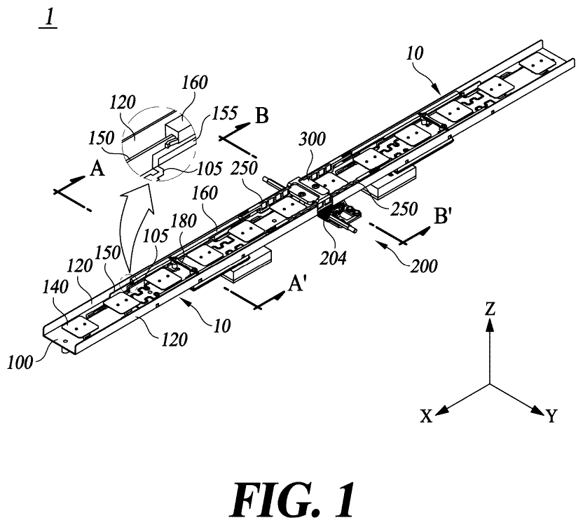

FIG. 1 is an exploded perspective view illustrating a part of an antenna device according to one embodiment of the present disclosure.

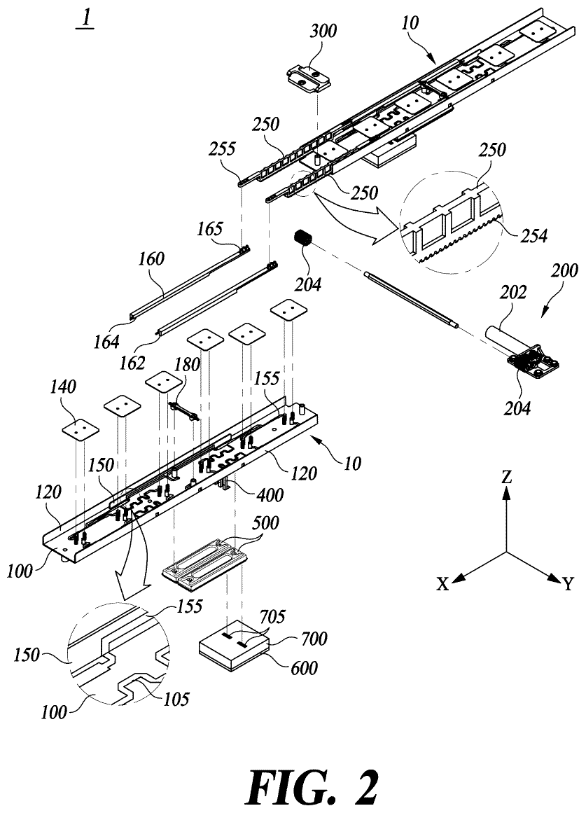

FIG. 2 is a combined perspective view as viewed from an upper side of the antenna device according to one embodiment of the present disclosure, and an enlarged view of some components thereof.

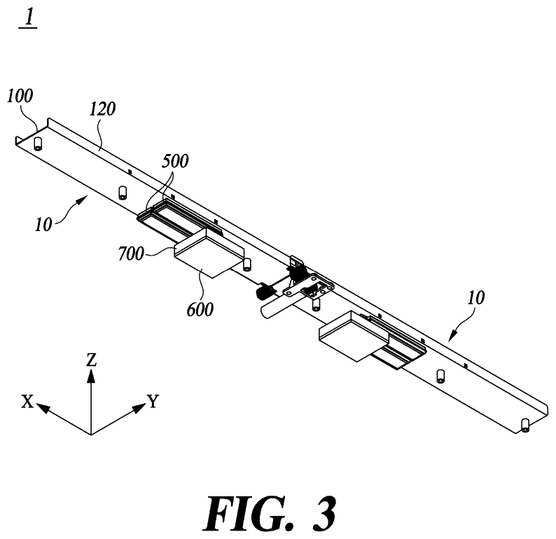

FIG. 3 is a combined perspective view as viewed from a lower side of the antenna device according to one embodiment of the present disclosure.

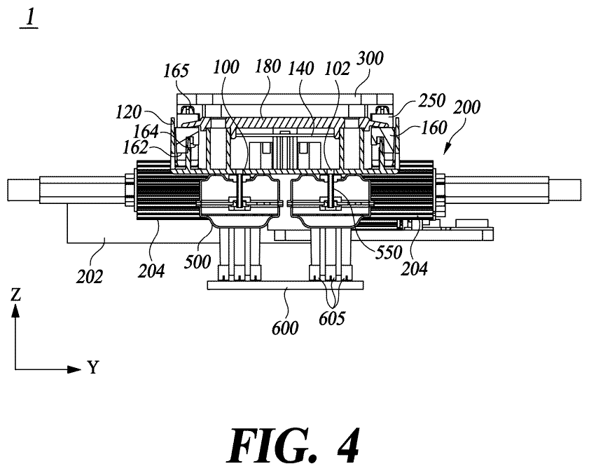

FIG. 4 is a cross-sectional view illustrating the antenna device of FIG. 2, taken along line A-A′ and shown with a cover removed.

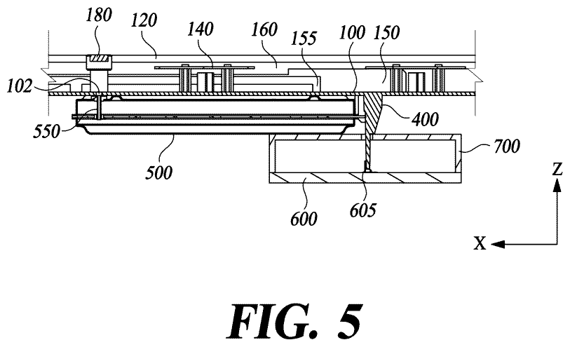

FIG. 5 is a cross-sectional view illustrating an area in which an antenna filter is disposed, taken along line B-B′ of the antenna device of FIG. 2.

Referring to FIGS. 1 to 5, an antenna device (1) according to one embodiment of the present disclosure includes all or some of at least one antenna board (10), at least one radiating element (140), a dielectric (160), at least one separation prevention portion (180), a driving portion (200), a pair of guide portions (250), a connector (400), an antenna filter (500), a digital board (600), and a cover (700).

At least one antenna board (10) is configured to extend in a longitudinal direction and to have at least one circuit pattern (105, 155) formed on each thereof. Here, the longitudinal direction may refer to, for example, a direction parallel to an X-axis in FIGS. 1 and 2.

Each of the at least one antenna board (10) may include at least one via hole (102) configured such that one surface thereof is penetrated to allow an antenna signal to pass there through. Through the via hole (102), the at least one circuit pattern (105, 155) and a connector (400), which will be described later, may be electrically connected to each other.

Meanwhile, each of the at least one antenna board (10) may include a base portion (100), a pair of ground walls (120), and a pair of pattern walls (150).

The base portion (100) is configured to extend in the longitudinal direction and to have a first circuit pattern (105) formed on one surface thereof.

The first circuit pattern (105) may be connected to at least one input port (not shown) and a plurality of output ports (not shown). In addition, the first circuit pattern (105) may receive an antenna signal from an antenna cable and may provide a movement path of the antenna signal.

Although FIG. 1 illustrates one example in which the first circuit pattern (105) is formed on one surface of the base portion (100), the shape of the first circuit pattern (105) is not necessarily limited to that illustrated in FIG. 1.

In addition, although FIGS. 1 and 2 illustrate that the antenna device (1) includes two antenna boards (10) spaced apart from each other in the longitudinal direction, the antenna device may be configured to include one or three or more antenna boards (10).

Hereinafter, description will generally be made on the assumption that the antenna device (1) includes one or two antenna boards (10). However, even when the antenna device (1) is configured to include three or more antenna boards (10), the following description may be applied in the same manner.

For example, when the two antenna boards (10) illustrated in FIGS. 1 and 2 are defined as one group, a plurality of groups may be arranged in a lateral direction perpendicular to the longitudinal direction. Here, the lateral direction may refer to a direction parallel to a Y-axis in FIGS. 1 and 2.

The pair of ground walls (120) extend from both lateral sides of the base portion (100) in a direction parallel to a height direction perpendicular to the base portion (100). Here, the height direction may refer to a direction parallel to a Z-axis in FIGS. 1 and 2.

Meanwhile, the base portion (100) and the pair of ground walls (120) may be preferably formed integrally with each other. In this case, a lateral thickness of each of the pair of ground walls (120) may be the same as a height-direction thickness of the base portion (100), but the present disclosure is not necessarily limited thereto.

The pair of pattern walls (150) are disposed to protrude from one surface of the base portion (100) in a direction parallel to the height direction. On at least one surface of each of the pair of pattern walls (150), a second circuit pattern (155) electrically connected to the first circuit pattern (105) may be formed.

For example, the pair of pattern walls (150) may extend long in the longitudinal direction and may be thin walls having a lateral thickness equal to a lateral thickness of the pair of ground walls (120), but the present disclosure is not necessarily limited thereto.

In addition, the second circuit pattern (155) may be formed on surfaces of the pair of pattern walls (150) facing each other and may be electrically connected to the first circuit pattern (105), and in this case, at least a portion of the second circuit pattern (155) may extend in the height direction, and at least another portion thereof may extend long in the longitudinal direction.

However, the second circuit pattern (155) is not necessarily required to be formed only on the pair of pattern walls (150). That is, the second circuit pattern (155) may be configured such that a part thereof is formed on the base portion (100). Meanwhile, the first circuit pattern (105) and the second circuit pattern (155) are distinguished merely according to main formation positions thereof, and may substantially constitute a single circuit pattern.

At least one radiating element (140) is fixed to one surface of the base portion (100) and is disposed between the pair of pattern walls (150). The at least one radiating element (140) is capable of transmitting and receiving electromagnetic waves and radiating high-frequency and low-frequency signals.

The at least one radiating element (140) may include a plurality of radiating elements (140), and in this case, the plurality of radiating elements (140) may be arranged on the base portion (100) in the longitudinal direction while having the same interval.

The dielectric (160) is configured such that a contact position with respect to at least one circuit pattern (105, 155) is changeable at an upper side of each of the at least one antenna board (10).

For example, as at least a portion of the dielectric (160) moves in the longitudinal direction between each of the pair of ground walls (120) and each of the pair of pattern walls (150), the contact position of the dielectric with respect to the circuit pattern may be changed. Through this, an electrical length of a transmission line through which electrical signals pass may be shortened or lengthened, whereby a phase difference between the signals may be adjusted.

In addition, since phase adjustment may be performed by applying a circuit pattern having a minimum path without using a separate movable circuit board, even when a phase conversion function is included in terms of a structural aspect, an overall size of the antenna device (1) may be reduced.

In addition, since phase conversion is implemented by applying a circuit pattern having a minimum path without generating a separate circuit pattern for phase conversion, path loss may be minimized. Accordingly, an overall amount of heat generation of the system may also be reduced, and thus volumes and weights of components for heat dissipation are reduced, whereby an overall volume and weight of the device may be reduced.

Meanwhile, for efficient phase difference adjustment, the pair of pattern walls (150) may be spaced apart from each other in a direction parallel to the lateral direction, and each of the pair of pattern walls (150) may be disposed adjacent to each of the pair of ground walls (120).

In addition, the dielectric (160) may be configured to surround at least a portion of each of the pair of pattern walls (150). In this case, when viewed from an upper side in the height direction, at least a portion of the pair of pattern walls (150) may be covered by the pair of dielectrics (160). Here, the pair of dielectrics (160) may be spaced apart from the base portion (100) in a direction parallel to the height direction.

As in the prior art, when a dielectric is disposed in parallel with a base surface from a ground surface, there has been a problem in that an area occupied by the dielectric increases and components are affected by the dielectric. In addition, when a dielectric is disposed on a pattern on a PCB, since permittivity becomes considerably high, a ceramic material is additionally required to be provided, which causes an increase in a unit cost and a weight of the overall antenna device.

The antenna device (1) according to one embodiment of the present disclosure allows the base portion (100) and the dielectric (160) to be further spaced apart from each other, and since the dielectric (160) is not disposed on the ground walls (120), the above-described problems of the prior art may be solved.

Meanwhile, referring to FIG. 4, with respect to each of the pair of pattern walls (150), each of the pair of dielectrics (160) may be configured such that at least a portion of a first free end (162) on one longitudinal side adjacent to each of the pair of ground walls (120) is closer to the base portion (100) than a second free end (164) on the other longitudinal side.

More specifically, at least a portion of the first free end (162) may be disposed at a position corresponding to a height at which the second circuit pattern (155) is formed, and the second free end (164) may be disposed at an upper side in the height direction than the second circuit pattern (155). Accordingly, interference with a contact of the dielectric with respect to the circuit pattern may be prevented.

In addition, at least one separation prevention portion (180) is fixed to one surface of each of the base portions (100) and is disposed between the pair of dielectrics (160). Here, at least a portion of the at least one separation prevention portion (180) is configured to be positioned at an upper side in the height direction of the pair of dielectrics (160) and to prevent the pair of dielectrics (160) from being separated in the height direction.

The at least one separation prevention portion (180) is preferably fixed to one surface of the base portion (100) so as not to overlap with the first circuit pattern (105).

Meanwhile, referring to FIG. 1, the driving portion (200) is disposed on one longitudinal side of the antenna board (10), and the pair of guide portions (250) are configured to be spaced apart from each other in the lateral direction and to be capable of reciprocating in a direction parallel to the longitudinal direction according to driving of the driving portion (200).

In this case, each of the pair of dielectrics (160) may be connected to each of the pair of guide units (250) so as to be capable of reciprocating in a direction parallel to the longitudinal direction according to movement of the pair of guide units (250). Accordingly, at least a portion of each of the pair of dielectrics (160) may be stably moved in the direction parallel to the longitudinal direction between each of the pair of ground walls (120) and each of the pair of pattern walls (150).

More specifically, the driving portion (200) may include a motor (202) configured to rotate with a motor shaft extending in a direction parallel to the lateral direction, and at least one pinion gear portion (204) configured to rotate about a central axis parallel to the motor shaft according to rotation of the motor (202).

The antenna device (1) according to one embodiment of the present disclosure is configured such that, as illustrated in FIG. 1, a pair of guide portions (250) receiving a driving force from a single motor (202) move the pair of dielectrics (160). Accordingly, there is no need to perform operations such as carving or cutting the base portion (100) and the pair of ground walls (120) in order to secure a movement path for the pair of dielectrics (160).

In FIG. 1, the at least one pinion gear portion (204) is illustrated as being composed of two pinion gear portions (204) spaced apart from each other in the lateral direction; however, the number of pinion gear portions (204) is not necessarily limited thereto, and the at least one pinion gear portion may be configured as a single pinion gear portion (204).

Here, each of the pair of guide portions (250) may include a rack gear portion (254) formed at a lower side in the height direction and configured to convert rotational motion of the at least one pinion gear portion (204) into linear motion. Accordingly, the pair of guide portions (250) may move in a direction parallel to the longitudinal direction according to rotational motion of the motor (202), and thus the pair of dielectrics (160) may also move in the direction parallel to the longitudinal direction.

In addition, in order to ensure stable coupling between each of the pair of guide portions (250) and each of the pair of dielectrics (160), each of the pair of dielectrics (160) may include at least one coupling protrusion (165), and each of the pair of guide portions (250) may include at least one coupling hole (255) formed to be coupled with the at least one coupling protrusion (165).

In this case, the at least one coupling protrusion (165) may be formed on an upper surface in the height direction of each of the pair of dielectrics (160), and the at least one coupling hole (255) may be formed on at least one longitudinal side of each of the pair of guide portions (250).

Here, it is preferable that a number of the at least one coupling protrusion (165) and a number of the at least one coupling hole (255) are the same. For example, as illustrated in FIGS. 1 and 2, the at least one coupling protrusion (165) and the at least one coupling hole (255) may each be provided in a number of three; however, the present disclosure is not necessarily limited to such a number.

Meanwhile, as illustrated in FIGS. 1 and 2, when the antenna device (1) according to one embodiment of the present disclosure includes a plurality of antenna boards (10) spaced apart from each other in the longitudinal direction, the driving portion (200) may be disposed between the plurality of antenna boards (10). In addition, the pair of guide portions (250) may be configured to extend long in a direction parallel to the longitudinal direction and to be spaced apart from one surface of the plurality of antenna boards (10) in a direction parallel to the height direction so as not to affect the first circuit pattern (105).

In this case, when viewed from one lateral side, at least a portion of the pair of guide portions (250) may be covered by the pair of ground walls (120) included in each of the plurality of antenna boards (10).

The pair of guide portions (250) may be configured to be disposed adjacent to the pair of ground walls (120) without interfering therewith. In this case, in order to secure movement of the pair of guide portions (250) in a direction parallel to the longitudinal direction, a longitudinal extension length of the pair of pattern walls (150) may be smaller than a longitudinal extension length of the pair of ground walls (120).

Meanwhile, since the pair of guide portions (250) are configured to guide movement of the pair of dielectrics (160), the pair of guide portions are preferably formed of a material that does not exert any electrical influence on the circuit pattern and the dielectric.

In addition, when the antenna device (1) according to one embodiment of the present disclosure includes a plurality of antenna boards (10) spaced apart from each other in the longitudinal direction, the antenna device (1) according to one embodiment of the present disclosure may further include an upper connection portion (300) configured to connect the plurality of antenna boards (10) to each other between the plurality of antenna boards (10).

For example, the upper connection portion (300) may be detachably coupled to upper surfaces in the height direction of each of the pair of guide portions (250). When the upper connection portion (300) is mounted on the upper surfaces in the height direction of each of the pair of guide portions (250), the plurality of antenna boards (10) may form one group. In this case, movement and replacement of components of the antenna device (1) may be facilitated.

Meanwhile, when a plurality of antenna boards (10) form one group, a plurality of groups may be arranged side by side in both the longitudinal direction and the lateral direction. For example, referring to FIG. 4, it may be seen that additional antenna boards (10) may be arranged on both lateral sides in addition to the illustrated antenna boards (10).

Among these, referring to an example in which antenna boards (10) are arranged in a positive Y-axis direction, the illustrated base portion (100) is disposed to be biased toward a negative Y-axis direction with respect to a center of the pinion gear portion (204), and thus another base portion (100) may be disposed on a side biased toward the positive Y-axis direction. In this case, a number of the pinion gear portions (204) may be increased, and a position of the motor (202) may be further moved in the positive Y-axis direction.

Meanwhile, when a plurality of antenna board (10) groups are additionally provided in the longitudinal direction, the driving portion (200), the pair of guide portions (250), and the upper connection portion (300) may be additionally provided on one longitudinal side or both longitudinal sides of the two base portions (100) illustrated in FIGS. 1 and 2.

The connector (400) is formed to protrude from one surface at a lower side of each of the at least one antenna board (10). For example, the connector (400) may be formed to protrude from a surface opposite to a surface of the base portion (100) on which the at least one circuit pattern (105, 155) is formed.

The connector (400) is configured to electrically connect an antenna filter (500) and a digital board (600), which will be described later, and the connector (400) and the antenna board (10) may preferably be integrally formed.

In this case, the connector (400) may be integrally formed together with the base portion (100), the pair of ground walls (120), and the pair of pattern walls (150) using a PEP (Plastic Electro-Plating) process.

When the PEP process is used, even without using a separate printed circuit board (PCB), a circuit pattern may be formed using a panel made of a plastic material, and a three-dimensional structure may be integrally injection-molded. Accordingly, an overall weight and cost of the antenna device (1) may be reduced.

The antenna filter (500) is detachably coupled to the connector (400). For example, the antenna filter (500) may be coupled to and detached from the connector (400) in a direction parallel to the longitudinal direction; however, the present disclosure is not necessarily limited thereto, and the antenna filter may be coupled to and detached from the connector in the height direction or the lateral direction.

In this case, since the antenna filter (500) is configured separately from the antenna board (10), replacement of only the antenna filter (500) may be facilitated.

Meanwhile, referring to FIG. 5, one longitudinal side of the antenna filter (500) may be electrically connected to the at least one circuit pattern (105, 155), and the other longitudinal side of the antenna filter (500) may be electrically connected to the connector (400).

Here, the antenna filter (500) may include a signal connection portion (550) formed on one longitudinal side thereof, and the signal connection portion (550) may be electrically connected to the via hole (102).

For efficient antenna signal transmission, with reference to the height direction, the antenna filter (500) and the dielectric (160) may be disposed such that at least portions thereof respectively correspond to each other with the at least one antenna board (10) interposed there between. That is, when the antenna filter (500) is coupled to the connector (400), a position of the antenna filter (500) on a lower surface of the base portion (100) may correspond to a position at which the dielectric (160) is disposed on an upper side of the base portion (100).

The digital board (600) is configured to be electrically connected to one end of the connector (400) in an extension direction thereof. Here, the antenna filter (500) may be positioned above the digital board (600) while being coupled to the connector (400).

Accordingly, when the digital board (600) and the antenna board (10) are coupled to each other, the antenna filter (500) may be positioned above the digital board (600) independently of the coupling, and thus the antenna filter (500) may not receive a load caused by the coupling between the digital board (600) and the antenna board (10).

In particular, when the antenna filter (500) according to one embodiment of the present disclosure is a bellow filter formed of a foldable sheet, the antenna filter may be vulnerable to an external load, but, with such an arrangement, the antenna filter (500) may be free from loads caused by other components.

Meanwhile, the digital board (600) may include an elastic support portion (605) formed on one surface thereof and configured to support the connector (400) and to be elastically deformable. In FIG. 4, the number of elastic support portions (605) is illustrated as three; however, the present disclosure is not necessarily limited thereto.

When an external force is applied in a state in which the antenna board (10) and the digital board (600) are coupled to each other, the elastic support portion (605) may provide a cushioning effect, and thus an external force acting on the antenna filter (500) may be minimized.

The cover (700) is configured to cover an upper side of the digital board (600). The cover (700) may serve to protect the digital board (600) from external impact and contaminants, and may also perform a function as a shielding wall.

The cover (700) may include a connector hole (705) formed on one surface thereof, for example, on an upper surface of the cover (700), to allow the connector (400) to pass there through. Through the connector hole (705), the connector (400) may pass through the cover (700) and be connected to the digital board (600).

As described above, the antenna device (1) according to one embodiment of the present disclosure implements a connector portion (400) connected to an RF chain in an antenna module, thereby minimizing a size of an antenna filter module and enabling more efficient utilization of an internal space. In addition, there is an effect of preventing damage to the antenna filter (500) caused by external impact and/or coupling and facilitating replacement of the antenna filter (500).

The above description is merely illustrative of the technical ideas of the present embodiment, and those skilled in the art to which the present embodiment belongs will be able to make various modifications and variations without departing from the essential characteristics of the present embodiment. Therefore, the present embodiments are intended to illustrate rather than limit the technical ideas of the present embodiment, and the scope of the technical ideas of the present embodiment is not limited by these embodiments. The scope of protection of the present embodiment should be construed in accordance with the following claims, and all technical ideas within an equivalent scope should be construed as being included within the scope of rights of the present embodiment.

[Description of Reference Numerals] 1: antenna device, 10: antenna board, 100: base portion, 102: via hole, 105: first circuit pattern, 120: ground wall, 140: radiating element, 150: pattern wall, 155: second circuit pattern, 160: dielectric, 162: first free end, 164: second free end, 165: coupling protrusion, 180: separation prevention portion, 200: driving portion, 202: motor, 204: pinion gear portion, 250: guide portion, 254: rack gear portion, 255: coupling hole, 300: upper connection portion, 400: connector, 500: antenna filter, 550: signal connection portion, 600: digital board, 605: elastic support portion, 700: cover, 705: connector hole

1. An antenna device comprising:
at least one antenna board extending in a longitudinal direction and configured such that at least one circuit pattern is formed on each of the at least one antenna board;
a dielectric configured such that a contact position for the at least one circuit pattern is changeable at an upper side of each of the at least one antenna board;
a connector protruding from one surface at a lower side of each of the at least one antenna board; and
an antenna filter detachably coupled to the connector.

2. The antenna device according to claim 1, wherein
one longitudinal side of the antenna filter is electrically connected to the at least one circuit pattern, and
the other longitudinal side of the antenna filter is electrically connected to the connector.

3. The antenna device according to claim 1, wherein
with reference to a height direction extending upward from the lower side of the at least one antenna board, the antenna filter and the dielectric are disposed such that at least portions thereof correspond to each other with the at least one antenna board interposed there between.

4. The antenna device according to claim 1, wherein
the antenna board and the connector are integrally formed using a PEP (Plastic Electro-Plating) process.

5.

5. The antenna device according to claim 1, further comprising:
a digital board configured to be electrically connected to one end of the connector in an extension direction thereof,
wherein the antenna filter is positioned above the digital board while being coupled to the connector.

6. The antenna device according to claim 5, wherein
the digital board comprises an elastic support portion formed on one surface thereof and configured to support the connector and to be elastically deformable.

7. The antenna device according to claim 5, further comprising:
a cover configured to cover an upper portion of the digital board,
wherein the cover comprises a connector hole formed on one surface thereof to allow the connector to pass there through.

8. The antenna device according to claim 1, wherein
the antenna filter is a bellow filter formed of a foldable sheet.

9. The antenna device according to claim 1, wherein
each of the at least one antenna board comprises:
a base portion configured such that a first circuit pattern is formed on one surface thereof;
a pair of ground walls extending from both lateral sides of the base portion in a direction parallel to a height direction perpendicular to the base portion; and
a pair of pattern walls disposed to protrude from one surface of the base portion in a direction parallel to the height direction, wherein each of the pair of pattern walls is configured such that a second circuit pattern electrically connected to the first circuit pattern is formed on at least one surface thereof.

10. The antenna device according to claim 9, wherein
the dielectric is configured to be movable in a direction parallel to the longitudinal direction,
and at least a portion of the dielectric is disposed between each of the pair of ground walls and each of the pair of pattern walls.

11. The antenna device according to claim 9, wherein
the pair of pattern walls are spaced apart from each other in a direction parallel to the lateral direction, and
each of the pair of pattern walls is disposed adjacent to each of the pair of ground walls.

12. The antenna device according to claim 9, further comprising:
at least one radiating element fixed to one surface of the base portion and disposed between the pair of pattern walls.
